(19) United States
(12) Patent Application Publication
(10) Pub. No.: US 2014/0071328 A1
(43) Pub. Date: Mar. 13, 2014

(54) SYSTEM AND METHOD FOR MATCHING A CAMERA ASPECT RATIO AND SIZE TO AN ILLUMINATION ASPECT RATIO AND SIZE

(71) Applicant: LOCKHEED MARTIN CORPORATION, BETHESDA, MD (US)

(72) Inventor: Edward Jozef Miesak, Windermere, FL (US)

(73) Assignee: LOCKHEED MARTIN CORPORATION, BETHESDA, MD (US)

(21) Appl. No.: 14/022,170

(22) Filed: Sep. 9, 2013

Related U.S. Application Data
(60) Provisional application No. 61/697,895, filed on Sep. 7, 2012.

(51) Int. Cl. G03B 15/06; H04N 5/232; H04N 5/225

(52) U.S. Cl. CPC G03B 15/06; H04N 5/2256; H04N 5/23212
USPC 348/340; 348/335; 348/342

(57) ABSTRACT

A system including an imaging device configured to capture an image of a target at a first aspect ratio and with a first field of view on the target, a light source configured to illuminate the target with a light at a second aspect ratio and with a second field of view on the target, and at least one optical baffle configured to shape the light at the target. The second aspect ratio equals the first aspect ratio and the second field of view equals the first field of view. Methods are also disclosed.

### CROSS-REFERENCE TO RELATED APPLICATIONS

This application claims the benefit of U.S. Provisional Application No. 61/697,895 filed Sep. 7, 2012, and incorporated herein by reference in its entirety.

### BACKGROUND

Embodiments relate to an imaging system and, more particularly, to a system and method to match an illuminated light at an equal aspect ratio as an illumination device and a size of a field of view of an imaging device on a target,

Light is required to illuminate a subject or target so that an imaging device, which may comprise a camera to photograph or take an image of the subject or target. A portion of a target that the imaging device photographs is within a field of view of the imaging device where the field of view is determined by a lens of the imaging device and a size or shape of an image collection sensor in the imaging device.

A light illuminating the target often over-fills the target since light reaches beyond the boundary established by the lens and sensor of the imaging device. Such over-filling can result in errant light bouncing back from, or reflecting from the surface and interfering with an image being captured.

Certain applications of imaging devices would benefit from an approach where the light illumination is narrowly focused, such as to approximately a same, or equal, size as an aspect angle of the imaging device. One such application is when an imaging device is used to optically lift a latent print or contaminant.

A latent print may be an invisible fingerprint impression, footprint impression, or palm print impression left on a surface following surface contact caused by the perspiration on ridges of an individual's skin coming in contact with the surface and leaving perspiration, sebum, waxes, oils, etc. behind, making an invisible or a partially visible impression on the surface as a result. Perspiration is known to contain water, salt, amino acids, and oils, which allows impressions to be made. The natural oils of the body preserve the print, where the impression left is utterly distinct so that no two humans have the same latent print.

Conventional methods for extracting fingerprints usually involve adding chemicals or powders to the print. Such conventional methods can present an immediate dilemma in that they force the investigator to make a decision as to whether to dust for prints versus swabbing for deoxyribonucleic acid (“DNA”) evidence. Either approach results in destroying, or removing, the prints as they are originally found since the prints are no longer on their original surface.

Automatic non-contact latent fingerprint detection systems are also known that avoid the need to add chemicals or powders that can disturb the surface chemicals of the fingerprint. Such systems generally include a single light source, utilize only diffuse reflectance (reject specular reflection (glare)) and some may even use specular reflection, and are generally limited to fingerprinting the area of one's finger, or an area about that size.

When clarity of an image is important, entities would benefit from a system and method where errant light does not interfere with an image capture.

### SUMMARY

Embodiments relate to a system and method for providing a equal aspect ratio for an imaging device and an illumination device upon a target and an equal size of a field of view of the imaging device on the target and a size of the illumination on the target. The system comprises an imaging device configured to capture an image of a target at a first aspect ratio and with a first field of view on the target. The system also comprises a light source configured to illuminate the target with a light at a second aspect ratio and with a second field of view on the target. The system also comprises at least one optical baffle configured to shape the light at the target. The second aspect ratio equals the first aspect ratio and the second field of view equals the first field of view.

A method comprises shaping an illumination aspect ratio of a light emitted from a light source to equal an aspect ratio of an imaging device at a target with at least one optical baffle. The method also comprises shaping a size of a field of view of the light emitted at the target to equal a field of view of the imaging device on the target. The method also comprises capturing an image of the target with the imaging device.

Another method comprises illuminating a target with an illumination source, and directing a path of the illumination to the target with at least one optical baffle. The method also comprises shaping an illumination aspect ratio of the illumination to equal an aspect ratio of an imaging device at a target with at least one optical baffle. The method also comprises shaping a size of a field of view of the illumination to equal a field of view of the imaging device on the target. The method also comprises capturing an image of the target with the imaging device.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows an embodiment of a light source;

FIG. 2 shows an embodiment of a part of a system unfolded;

FIG. 3 shows an embodiment of a part of a system;

FIG. 4 shows another embodiment of a part of a system;

FIG. 5 show an embodiment of the system;

FIG. 6 shows embodiments of aspect ratios;

FIG. 7 shows a block diagraph representation of an embodiment of a sensor;

FIG. 8 shows a flowchart illustrating an embodiment of a method; and

FIG. 9 shows another flowchart illustrating an embodiment of a method.

### DETAILED DESCRIPTION

Embodiments are described herein with reference to the attached figures, wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required. to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Though embodiments are disclosed with respect to imaging a latent fingerprint, embodiments are also applicable to other latent markings or prints as well, such as, but not limited to, a footprint a palm print, etc. As used herein, “latent print” comprises a latent fingerprint and other imprints that may be recognizable to distinguish an entity from another. Latent fingerprints, which are impressions left by the friction ridges of a human finger, may be composed of almost any material, including, but not limited to, grease, oil, sweat, wax, etc. “Latent” as used with respect to fingerprints and/or other prints means a chance or accidental impression left on a surface, regardless of whether visible or invisible at time of deposition. Embodiments are also application to other surface contaminants as well. The term “contaminant” is not limited as it can also apply to a latent print as well. Other non-limiting examples of a contaminant may include blood or another body fluid, non-bodily fluids, oils, greases, dusts, dirt, water residue, other particulates, a fracture in a surface, a physical defect in the surface, etc. Furthermore, as used herein as used herein, having an equal shape and/or size, with respect to aspect ratio and field of view, includes a tolerance of approximately plus or minus ten percent (+1-10%).

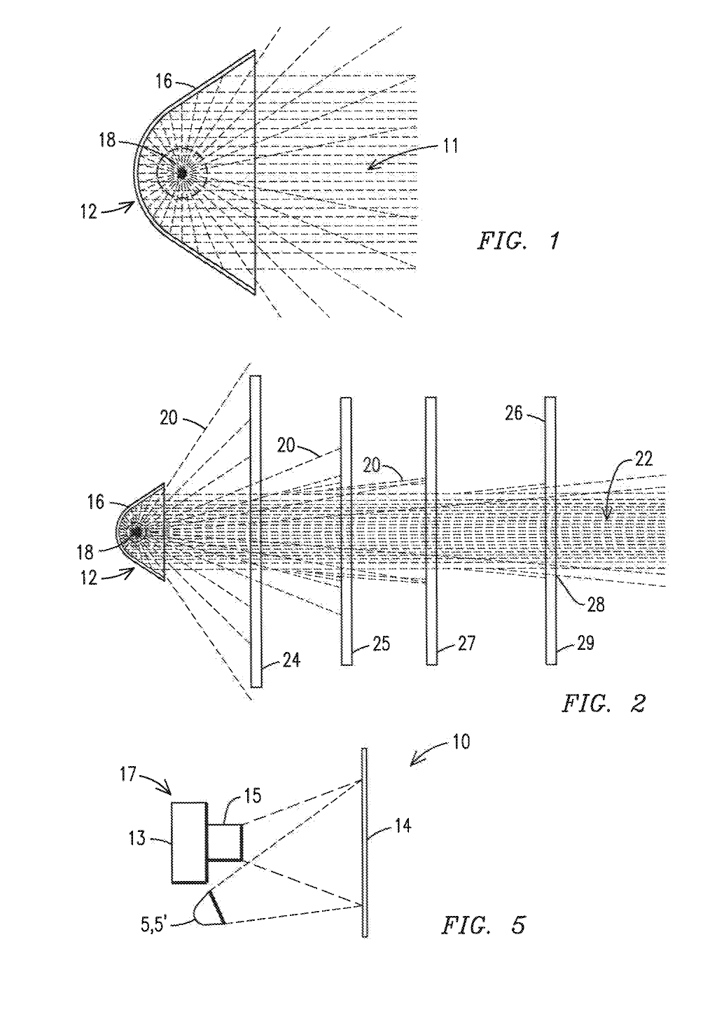

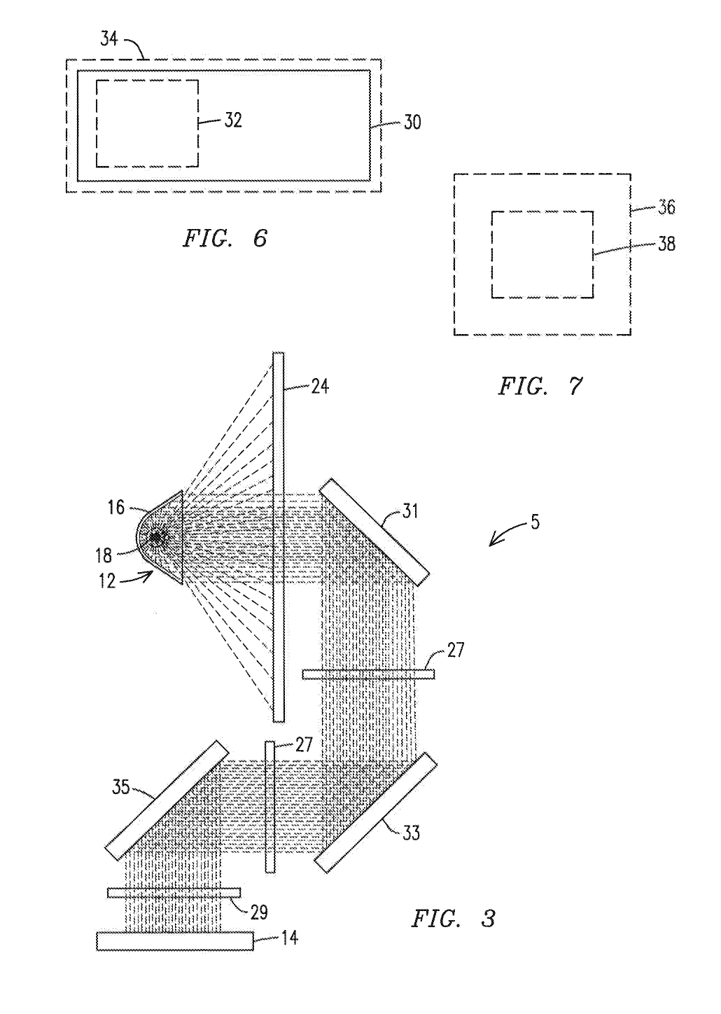

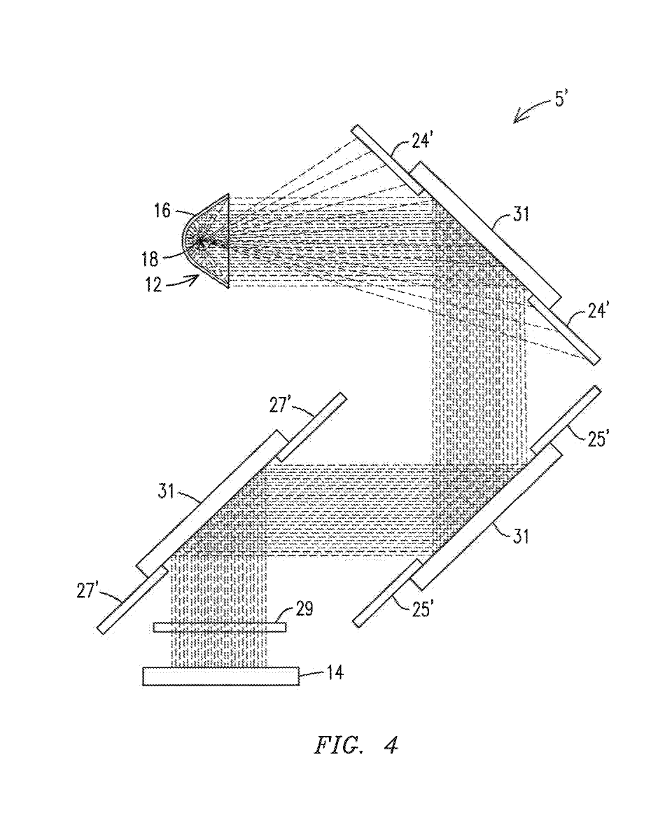

FIG. 1 shows an embodiment of a light source, or illumination source. A light source 12 that may to be used to illuminate a target is disclosed. In an embodiment, the light source 12 may be a plasma flash lamp which generally propagates in all directions and needs to be processed before it is used to illuminate the target. In another embodiment, the light source 12 may be a laser, which features a minimal increase in diameter as light propagates. As a non-limiting example, the target may be a latent fingerprint on a surface. As illustrated in FIG. 1, the light from the light source 12 propagates in all directions. A reflector 16 may be positioned such that the source 18 is located at the focal point of the reflector 16. As a non-limiting example, the reflector 16 may be a spherical or parabolic reflector. As a result of positioning the reflector 16, the light 11, or illumination, emitted from the source 12 has a reduced spread. The source 12 may be spectrally filtered, to enhance a photographic result of illuminating the target, as illustrated in FIGS. 3 and 4.

FIG. 2 shows an embodiment of a part of a system. Optical baffles 24, 25, 27, 29 are disclosed with the light source 12, wherein for this illustration, the baffles are in an unfolded configuration. Though four optical baffles are illustrated, any number may be used. Optical baffles 24, 25, 27, 29 are positioned in a path of the light 11 illuminated from the source 12 and reflector 16. Each optical baffle 24, 25, 27, 29 includes an opaque screen 26 on a side closest to the source 12 to limit, or block a high diverging portion 20 of the light 11 and an opening 28, to permit a low diverging portion 22 of the light 11 to pass through the optical baffles 24, 25, 27, 29. Thus, as illustrated, upon propagating through the optical baffles 24, 25, 27, 29, the high diverging portion 20 of the light 11 is obstructed and the low diverging 22 portion of the light 11 is transmitted through the optical baffles 24, 25, 27, 29. In addition to removing the high diverging portion 20 of the light 11, the optical baffles 24, 25, 27, 29 are used to shape an illumination aspect ratio, as discussed below. At least one baffle may be configured to operate as a lens. As a non-limiting example, the opaque screen may be adjustable to reduce a diameter, or size, of an opening through at least one baffle. As another non-limiting example, a separate lens is provided to control, or adjust, a size of a diameter of the opening in at least one baffle 24, 25, 27, 29.

FIG. 3 shows an embodiment of an illumination system. The optical baffles 24, 25, 27, 29 are disclosed with the light source 12 as a part of the illumination system 5. Mirrors 31, 33, 35 are provided as spectral filters. Though three mirrors are illustrated, any number may be used. Additionally the light filtered by any minor is not necessarily required to then pass through a baffle as disclosed. Thus, those skilled in the art will recognize that a plurality of variations is possible where a number of mirrors and baffles may be varied. In operation, the illumination system 5 may be housed in an enclosure.

FIG. 4 shows another embodiment of an illumination system. In this illumination system 5′, instead of having optical baffles separate from the mirrors 31, 33, 35, the optical baffles, 24′, 25′ and 27′ may be a part of the mirror or may be provided to hold a respective mirror in place. These optical baffles 24′, 25′, and 27′ provide the same features as the baffles disclosed above.

FIG. 5 illustrates an illumination system in combination with an imaging device. The imaging device 17 may comprise a camera 13 and lens 15. The imaging system in combination with the illumination system may form a system 10 for photographing a target 14. The target is not a part of the system 10. In an embodiment, the system 10 includes the light source 12 to generate the light 11, in coordination with the reflector 16 and the optical baffles 24, 25, 27, 29 (though the reflector 16 or optical baffles 24, 25, 27, 29 are not expressly illustrated in FIG. 3), which illuminates the target 14 with a specific illumination aspect ratio. Thus, the illumination system 5, 5′ disclosed above, or a variation of either may also be used. As appreciated by one skilled in the art, an aspect ratio is a proportional relationship between width and height. Thus, the illumination aspect ratio is the proportional relationship between a width and a height of the light 11 on the target 14. As discussed above, the optical baffles 24, 25, 27, 29, may be used to vary the illumination aspect ratio of the light 11 on the target 14. Thus, the optical baffles 24, 25, 27, 29 may be configured to shape an illumination aspect ratio of the light 11 on the target 14 to the imaging device aspect ratio and provide the light to have at an equal size, +/−10%, as a field of view of the camera field of view on the target 14.

As further illustrated in FIG. 5, the system 10 includes the imaging device 17 having a camera 13 with a lens 15, to capture an image of the target 14 which is captured on an image sensor of the camera 13. The lens 15 forms the image to be captured of the target 14, upon the illumination of the target 14 by the light source 12. The image sensor has an inherent aspect ratio which predetermines an image aspect ratio of the captured target image by the imaging device 17. Before the camera 13 captures the target image, an image of the target 14 may be projected by the lens 15 onto the camera 13 sensor, with a projected image aspect ratio. If the projected image aspect ratio of the target 14 lies outside the sensor aspect ratio of the imaging device 17, the generated target image will not include every portion of the projected target image. Thus, in order for the entire projected target image to be generated by the imaging device, the projected image aspect ratio needs to be equal to the sensor aspect ratio. Thus, the lens 15 may be selectively adjusted, such that the projected image aspect ratio is equal to the sensor aspect ratio or the imaging device aspect ratio. The optical baffles 24, 25, 27, 29 also provide the light 11 so that it has an equal size, +/−10%, as a field of view of the camera field of view on the target.

FIG. 6 illustrates an embodiment, in which a projected image aspect ratio 30 is not equal to a first camera sensor aspect ratio 32, and thus a portion of the projected target image would not appear in the generated target image. FIG. 6 further illustrates a second camera sensor aspect ratio 34 which is equal to the projected image aspect ratio 30, and thus the imaging device 17 would generate an image with every portion of the projected target image. To achieve the second aspect ratio 34, the lens 15 may be selectively adjusted.

In addition to an inherent aspect ratio, the image sensor of the imaging device 17 may have an inherent number of pixels. For a fixed lens magnification, the resolution of the imaging device 17 may be based on the number of sensor pixels, divided by an adjustable size of the image sensor. Thus, if the size of the image sensor is increased, the resolution is decreased, and if the size of the image sensor is decreased, while keeping the number of pixels constant, the resolution is increased. A preferred image resolution for a latent print or a surface contamination is approximately one thousand (1000) pixels per inch in both a vertical and horizontal direction, Which are about one million pixels per square inch. Thus, a number of pixels on the image sensor divided by one million is equal to a number of square inches of target space that may be photographed at a time. As another non-limiting example, another approach to increase resolution is to increase a number of pixels while keeping a size of the image sensor constant.

FIG. 7 illustrates an increased size 36 of the image sensor and a reduced size 38 of the image sensor, such that the imaging device 17 may have a reduced resolution at the increased size 36 and an increased resolution at the decreased size 38. However, a number of pixels is the same in both image sensors illustrated.

During use of the system 10, a minimum required resolution of an image of the target 14 is first determined, along with a required size and aspect ratio of the image. For example, if the target 14 is a latent fingerprint, the minimum required resolution is 1 million pixels per square inch, the required size of the target image is 1 square inch and the required aspect ratio is 1:1. The camera 13 and lens 15, or the imaging device 17, are then selected, based on the inherent number of pixels in the camera 13, and magnification of the lens 15, and whether the resolution is at least equal to a minimum required resolution, when the image sensor size is adjusted to the size of the target. As a non-limiting example, a camera with 5 million pixels and lens with a magnification of one (1) could be used to image the latent fingerprint since the camera would have a resolution of 5 million pixels per square inch (greater than the minimum required resolution), when the image sensor size is adjusted to the required image size of 1 square inch. The light source 12 is then selected, along with the optical baffles 24,25,27,29, such that the illumination aspect ratio of the light 11 on the target 14 is equal to the image sensor aspect ratio of the imaging device 17. They are also selected so that the light pattern on the target 14 should also an equal size, +/−10%, as the imaging device's field of view on the target. Though the above non-limiting example discusses selecting a camera 13 and lens 15, the camera 13 or lens 15 may be capable of simply being adjusted as oppose to selecting a specific camera and lens.

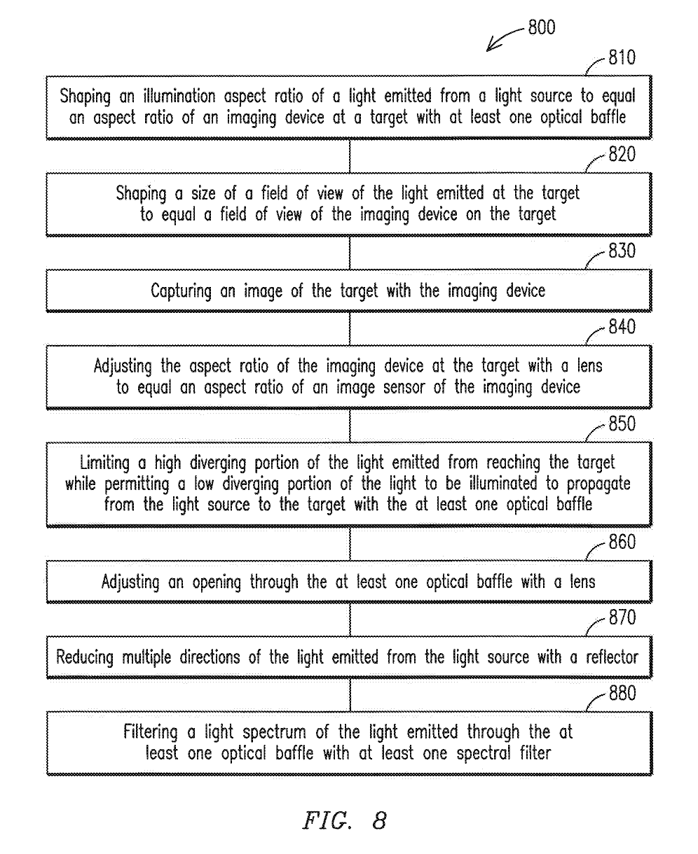

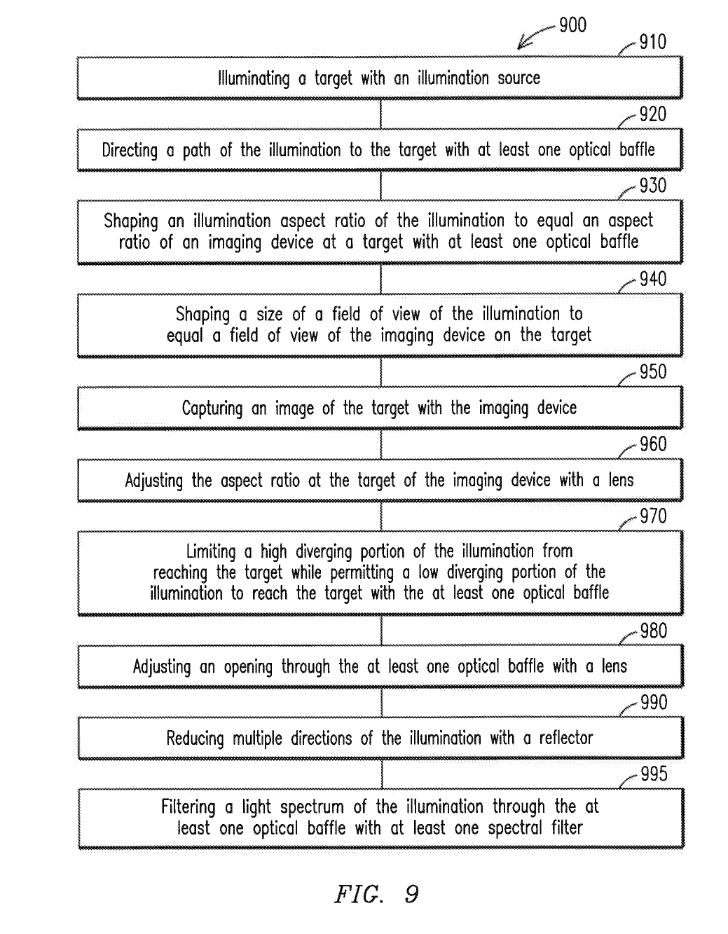

FIG. 8 shows a flowchart illustrating an embodiment of a method. The method 800 comprises shaping an illumination aspect ratio of a light emitted from a light source to equal. an aspect ratio of an imaging device at a target with at least one optical baffle, at 810. The method further comprises shaping a size of a field of view of the light emitted at the target to equal a field of view of the imaging device on the target, at 820. The method further comprises capturing an image of the target with the imaging device, at 830.

The method may further comprise adjusting the aspect ratio of the imaging device at the target with a lens to equal an aspect ratio of an image sensor of the imaging device, at 840. The method may further comprise limiting a high diverging portion of the light emitted from reaching the target while permitting a low diverging portion of the light to be illuminated to propagate from the light source to the target with the at least one optical baffle, at 850. The method may further comprise adjusting an opening through the at least one optical baffle with a lens, at 860. The method may further comprise reducing multiple directions of the light emitted from the light source with a reflector, at 870. The method may further comprise filtering a light spectrum of the light emitted through the at least one optical baffle with at least one spectral filter, at 880.

FIG, 9 shows a flowchart illustrating an embodiment of a method. The method 900 illuminating a target with an illumination source, at 910. The method also comprises directing a path of the illumination to the target with at least one optical baffle, at 920. The method 900 further comprises shaping an illumination aspect ratio of the illumination to equal an aspect ratio of an imaging device at a target with at least one optical baffle, at 930. The method further comprises shaping a size of a field of view of the illumination to equal a field of view of the imaging device on the target, at 940. The method further comprises capturing an image of the target with the imaging device, at 950.

The method further comprises adjusting the aspect ratio at the target of the imaging device with a lens, at 960. The method also comprises limiting a high diverging portion of the illumination from reaching the target while permitting a low diverging portion of the illumination to reach the target with the at least one optical baffle, at 970. The method further comprising adjusting an opening through the at least one optical baffle with a lens, at 980. The method further comprising reducing multiple directions of the illumination with a reflector, at 990. The method further comprising filtering a light spectrum of the illumination through the at least one optical baffle with at least one spectral filter, at 995.

Though the steps illustrated in the flowchart of the methods and provided in a particular sequence, these sequences are not meant to be limiting as those skilled in the art will recognize that these steps may be performed in any particular order. Based on the disclosure above, the system and methods may be used to ensure that light is most efficiently utilized to where a smaller, such as, but not limited to, where smaller means less illumination is available, light source may be used.

While various disclosed embodiments have been described above, it should be understood that they have been presented by way of example only, and not limitation. Numerous changes to the subject matter disclosed herein can be made in accordance with the embodiments disclosed herein without departing from the spirit or scope of the embodiments. In addition, while a particular feature may have been disclosed with respect to only one of several implementations, such feature may be combined with one or more other features of the other implementations as may be desired and advantageous for any given or particular application.

Therefore, the breadth and scope of the subject matter provided herein should not be limited by any of the above explicitly described embodiments. Rather, the scope of the embodiments should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second., etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Thus, while embodiments have been described with reference to various embodiments, it will be understood by those skilled in the art that various changes, omissions and/or additions may be made and equivalents may be substituted for elements thereof without departing from the spirit and scope of the embodiments. in addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered.

What is claimed is:

1. A system comprising:
an imaging device configured to capture an image of a target at a first aspect ratio and with a first field of view on the target;
a light source configured to illuminate the target with a light at a second aspect ratio and with a second field of view on the target; and
at least one optical baffle configured to shape the light at the target wherein the second aspect ratio equals the first aspect ratio and the second field of view equals the first field of view.

2. The system according to claim 1, wherein the imaging device further comprises an image sensor with an image sensor aspect ratio at the sensor.

3. The system according to claim 3, wherein the imaging device further comprises a lens configured to adjust the first aspect ratio to equal as an aspect ratio of the image sensor aspect ratio.

4. The system according to claim 1, wherein the at least one optical baffle comprises an opening to permit a low diverging portion of the light to propagate from the light source to the target.

5. The system according to claim 1, wherein the at least one optical baffle comprises at least one opaque screen.

6. The system according to claim 1, wherein the at least optical baffle is configured to limit a high diverging portion of the light from reaching the target.

7. The system according to claim 1, wherein the at least one optical baffle further comprises a lens configured to adjust a size of an opening through the optical baffle.

8. The system according to claim I, wherein the at least one optical baffle further comprises at least one spectral filter configured to filter a light spectrum of the illuminated light.

9. A method comprising:
shaping an illumination aspect ratio of a light emitted from a light source to equal an aspect ratio of an imaging device at a target with at least one optical baffle;
shaping a size of a field of view of the light emitted at the target to equal a field of view of the imaging device on the target; and
capturing an image of the target with the imaging device.

10. The method according to claim 9, further comprising adjusting the aspect ratio of the imaging device at the target with a lens to equal an aspect ratio of an image sensor of the imaging device.

11. The method according to claim 9, further comprising limiting a high diverging portion of the light emitted from reaching the target while permitting a low diverging portion of the light to be illuminated to propagate from the light source to the target with the at least one optical baffle.

12. The method according to claim 9, further comprising adjusting an opening through the at least one optical baffle with a lens.

13. The method according to claim 9, further comprising reducing multiple directions of the light emitted from the light source with a reflector.

14. The method according to claim 9, further comprising filtering a light spectrum of the light emitted through the at least one optical baffle with at least one spectral filter.

15. A method comprising:
illuminating a target with an illumination source;
directing a path of the illumination to the target with at least one optical baffle;
shaping an illumination aspect ratio of the illumination to equal an aspect ratio of an imaging device at a target with at least one optical baffle;
shaping a size of a field of view of the illumination to equal a field of view of the imaging device on the target; and
capturing an image of the target with the imaging device.

16. The method according to claim 15, further comprising adjusting the aspect ratio at the target of the imaging device with a lens.

17. The method according to claim 15, further comprising limiting a high diverging portion of the illumination from reaching the target while permitting a low diverging portion of the illumination to reach the target with the at least one optical baffle.

18. The method according to claim 15, further comprising adjusting an opening through the at least one optical baffle with a lens.

19. The method according to claim 15, further comprising reducing multiple directions of the illumination with a reflector.

20. The method according to claim 15, further comprising filtering a light spectrum of the illumination through the at least one optical baffle with at least one spectral filter.
